(19) United States
(12) Patent Application Publication
(10) Pub. No.: US 2009/0279523 A1
(43) Pub. Date: Nov. 12, 2009

(54) WIRELESS COMMUNICATION APPARATUS AND WIRELESS COMMUNICATION METHOD

(75) Inventors: Hiroshi Doi, Osaka (JP); Taisuke Matsumoto, Osaka (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/441,323

(22) PCT Filed: Sep. 6, 2007
(86) PCT No.: PCT/JP2007/067436

§ 371 Date: Mar. 31, 2009

(30) Foreign Application Priority Data
Sep. 15, 2006 (JP) 2006-251924
Sep. 3, 2007 (JP) 2007-227910

(51) Int. Cl. H04W 84/02

(52) U.S. Cl. 370/338

(57) ABSTRACT

Provided is a wireless communication apparatus wherein random multi-access can be performed while ensuring a transmission distance, even with a radio wave having directivity. A wireless communication apparatus (100) transmits/receives directional radio waves and performs ad hoc network communication with other wireless communication apparatuses. The wireless communication apparatus is provided with an antenna (110) for transmitting/receiving the directional radio waves and switching the directivity, and a control section (132) for controlling timing for switching the directivity of the antenna.

### TECHNICAL FIELD

The present invention relates to a wireless communication apparatus and wireless communication method. More particularly, the present invention relates to a wireless communication apparatus and wireless communication method in ad-hoc network in a mobile environment.

### BACKGROUND ART

PAN (Personal Area Network) refers to a network technique that has been developed recently. The specification of WiMedia that utilizes microwave UWB (Ultra Wide Band) in particular is employed as the ECMA (European Computer Manufacturer Association) standard, and shipping of products is close at hand. Further, the specification of WiMedia is employed as the wireless USB (Universal Serial Bus) standard and, consequently, it is expected that products will spread widely in the market in future.

Technical features of WiMedia MAC (Media Access Control) include a beacon period scheme. This scheme refers to a technique whereby all devices transmit and exchange beacons such that positions of beacons transmitted from distributed autonomous devices (i.e. nodes) located in the next-near field ranges do not overlap and carry out communication by declaring reservation of MAS (Media Access Slot) so as not to infringe upon the reservation slot already secured by other device.

In addition to this, recently, the standard committee such as IEEE802.15.3C focuses upon a technique utilizing UWB in the millimeter frequency band as the high speed radio technique compared to the microwave frequency band although the transmission distance is short compared to the microwave frequency band. This technique is under discussion aiming at exchanging data of a large file size such as moving images at the ticket gate of a station and the like as in touch and move.

Apart from the microwaves, the radio waves of the millimeter waves have directivity. The beacon period scheme of WiMedia assumes non-directional radio waves and the MAC scheme cannot be simply applied as is to the WiMedia scheme. As a result, discussion is under way in IEEE802.15.3C focusing upon communication which assumes transmission from fixed antennas for a party in a fixed location.

Further, Patent Document 1 discloses a technique of carrying out one-to-many communication using sector antennas in the millimeter wave frequency band between the base station in a fixed location and affiliate stations.

### Patent Document 1: Japanese Patent Application Laid-Open No. 2004-72523

### DISCLOSURE OF INVENTION

### Problems to be Solved by the Invention

According to the above conventional technique, it is difficult to realize multiple-access between devices in random locations, not in a fixed manner. Taking into account the above current condition, to realize the beacon period scheme for enabling multiple-access between devices in random locations, not in a fixed manner, utilizing sector antenna means is possible. This is a means to make a plurality of directional antennas to face all directions on a two dimensional plane pseudo omni-directional antennas.

However, if a plurality of directional antennas is used at the same time in this way, other communication apparatuses are influenced, and, therefore, the overall transmission power transmitted at one time is limited. As a result, transmission output from one sector antenna cannot help being decreased. Therefore, in addition to that the transmission distance cannot be secured very much in case of millimeter waves, if sector antennas are employed, there is a problem that the transmission distance becomes shorter.

It is therefore an object of the present invention to provide a wireless communication apparatus and wireless communication method for securing the transmission distance and realizing random multiple-access even with directional radio wave.

### Means for Solving the Problem

The wireless communication apparatus according to the present invention that transmits and receives a directional radio wave and carries out ad-hoc network communication with another wireless communication apparatus, employs a configuration including: an antenna that transmits and receives the directional radio wave and switches a directivity; and a controlling section that controls a switching timing of the directivity of the antenna.

### ADVANTAGEOUS EFFECT OF THE INVENTION

According to the present invention, it is possible to secure the transmission distance and realize random multiple-access communication between terminals in two dimensional or three dimensional space even with directional radio wave.

### BRIEF DESCRIPTION OF DRAWINGS

FIG. 1 is a block diagram showing a configuration of the wireless communication apparatus according to Embodiment 1 of the present invention;

FIG. 2 shows a configuration example of a sector antenna according to Embodiment 1;

FIG. 3 shows a superframe configuration according to Embodiment 1;

FIG. 4 is a flowchart of when superframe synchronization is acquired according to Embodiment 1;

FIG. 5 shows bit flags showing information related to a presence of other device in a beacon according to Embodiment 1;

FIG. 6 illustrates use conditions of superframes of when a plurality of devices acquire synchronization according to Embodiment 1;

FIG. 7 shows a method of utilizing an empty sub-superframe according to Embodiment 1;

FIG. 8 is a block diagram showing the configuration of the wireless communication apparatus according to Embodiment 2 of the present invention;

FIG. 9 illustrates of the principle of axis alignment between nodes according to Embodiment 2;

FIG. 10 is a flowchart showing axis alignment processing according to Embodiment 2;

FIG. 11 shows a configuration of beacon information according to Embodiment 2; and

FIG. 12 is a flowchart of synchronization control processing according to Embodiment 2.

### BEST MODE FOR CARRYING OUT THE INVENTION

Hereinafter, embodiments of the present invention will be described in detail using the accompanying drawings.

### Embodiment 1

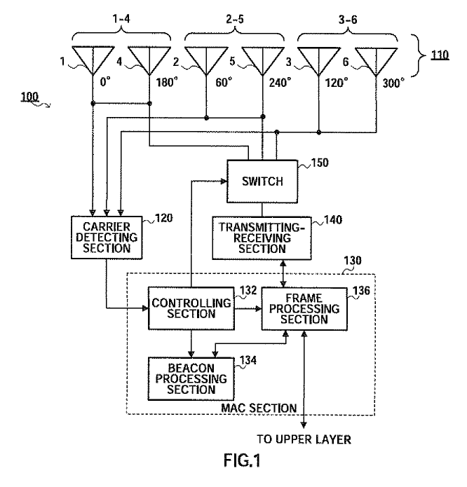

FIG. 1 is a block diagram showing a configuration of a wireless communication apparatus according to Embodiment 1 of the present invention.

Wireless communication apparatus 100 shown in FIG. 1 has sector antenna 110, carrier detecting section 120, MAC section 130, transmitting-receiving section 140 and switch 150. Each antenna element having directivity and forming sector antenna 110 is referred to as a “sector” and, for example, a pair of sector 1 and sector 4 facing opposite directions (having opposite directivities) is expressed as “transmitting-receiving pair 1-4.” Transmitting-receiving pairs 1-4, 2-5 and 3-6 are formed with sector 1 and sector 4, sector 2 and sector 5, and sector 3 and sector 6, respectively. Further, MAC section 130 is formed with controlling section 132, beacon processing section 134 and frame processing section 136.

Further, the direction of a sector refers to the direction in which the antenna gain of an antenna element is maximum. According to the present invention, for this direction, a direction matching with the direction of the center line of the radio wave reachable range is used.

According to the above configuration, wireless communication apparatus 100 of the present embodiment makes it possible to secure the transmission distance and realize random multiple-access even with directional radio wave.

With the present embodiment, a beacon period scheme using superframes is employed. To acquire superframe synchronization on a distributed autonomous network, all devices joining the wireless network line up and transmit beacons to check that the devices recognize each other. At this point, a plurality of devices transmits to each other information showing that there is the beacon of device A in the X-th slot. Here, when a given device receives beacons of other devices, this device judges whether or not its address is written in a slot transmitted from the device in one of received beacons. If, as a result of decision, the device recognizes that its address is not written, this device judges that an overlap (i.e. collision) has taken place, and moves to another slot. As a result, the device is able to obtain a list of the addresses of devices in a near-field or next-near field, which is useful to determine the slot to transmit the beacon of the device.

Sector antenna 110 is formed by arranging 2N sectors (where N is an integer equal to or more than two) such that transmission and reception are possible omni-directionally. Then, a superframe is evenly divided into N sub-superframes in association with sector antenna 110 and the sub-superframes are associated with N transmitting-receiving pairs respectively. Transmitting-receiving section 140 transmits and receives a sub-superframe from an applicable transmitting-receiving pair associated in each sub-superframe period. When transmission and reception of the sub-superframe is finished, the transmitting-receiving pair is switched, and, if necessary, transmission and reception of the next sub-superframe is carried out by the transmitting-receiving pair associated with its sub-superframe. A case of N=3 is described with the present embodiment.

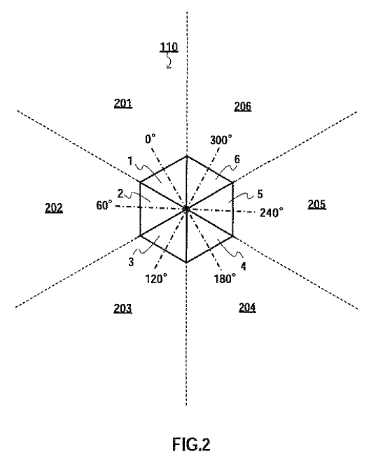

Next, referring to FIG. 2, a configuration of sector antenna 110 according to the present embodiment will be described. With the present embodiment, entire sector antenna 110 is divided into transmitting-receiving pairs 1-4, 2-5 and 3-6 and six sectors 1, 2, 3, 4, 5 and 6 are arranged on a two dimensional plane. That is, transmitting-receiving pair 1-4, transmitting-receiving pair 2-5 and transmitting-receiving pair 3-6 are formed with sector 1 and sector 4, sector 2 and sector 5, sector 3 and sector 6, respectively.

Further, the surrounding areas of sector antenna 110 are divided into six areas of areas 201, 202, 203, 204, 205 and 206. The antenna of sector 1 has the directivity in the direction of area 201 and is able to transmit and receive data to and from devices in area 201. Similarly, the antennas of sectors 2, 3, 4, 5 and 6 are able to transmit and receive data to and from devices in areas 202, 203, 204, 205 and 206 respectively.

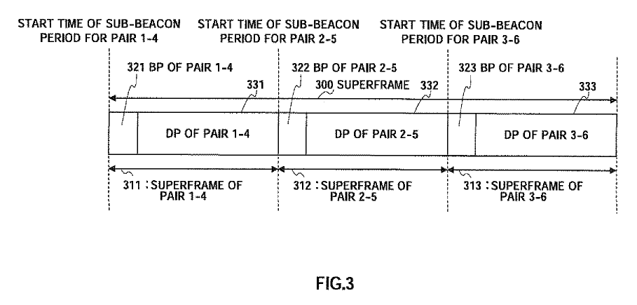

Next, referring to FIG. 3, the superframe configuration according to the present embodiment will be described. Superframe 300 is evenly divided into three sub-superframes. That is, superframe 300 is formed with sub-superframe 311 of pair 1-4, sub-superframe 312 of pair 2-5 and sub-superframe 313 of pair 3-6, from the left. The wireless communication apparatus according to the present embodiment (hereinafter the “device”) transmits and receives data to and from all devices in the near field and next-near field, by using this superframe. Further, each sub-superframe is fixed in association with each of a plurality of transmitting-receiving pairs, and is one of a plurality of sub-superframes forming a superframe.

Sub-superframe 311 of pair 1-4 is formed with beacon period 321 of pair 1-4 positioned at the top and data period (DP) 331 of pair 1-4. The top of beacon period 321 of pair 1-4 is the start time of the sub-beacon period of pair 1-4. Sub-superframe 312 of pair 2-5 and sub-superframe 313 of pair 3-6 can be construed likewise. Further, the start of superframe 300 may be the start time of the sub-beacon period of pair 1-4 or may be the start time of the sub-beacon period of pair 2-5 or the start time of the sub-beacon period of pair 3-6. The beacon transmitted and received by transmitting-receiving pair 1-4 and the frame transmitted and received by transmitting-receiving pair 1-4 are written in beacon period of pair 1-4 and data period 331 of pair 1-4, respectively. The same applies to beacon periods 322 and 323 and data periods 332 and 333 of pair 2-5 and pair 3-6.

Sub-superframe 311 of pair 1-4 is transmitted and received by the transmitting-receiving pair (i.e. antenna pair) of sector 1 and sector 4, sub-superframe 312 of pair 2-5 is transmitted and received by the transmitting-receiving pair of sector 2 and sector 5, and sub-superframe 313 of pair 3-6 is transmitted and received by the transmitting-receiving pair of sector 3 and sector 6.

Next, referring to FIG. 1, components of wireless communication apparatus 100 will be described in detail.

As described above, in sector antenna 110, transmitting-receiving pair 1-4 is formed with sector 1 and sector 4, and sector 1 and sector 4 face opposite directions forming an angle of 180 degrees with respect to each other (see FIG. 1 and FIG. 2). Similarly, transmitting-receiving pair 2-5 is formed with sector 2 and sector 5, and sector 2 and sector 5 face opposite directions forming an angle of 180 degrees with respect to each other, so that the directivities are opposite. Further, transmitting-receiving pair 3-6 is formed with sector 3 and sector 6, and sector 3 and sector 6 face opposite directions forming an angle of 180 degrees with respect to each other. The orientation of sector 2 is directed to 60 degrees counterclockwise from sector 1 and the orientation of sector 3 is directed to 120 degrees counterclockwise from sector 1. Sector 1 functions as an antenna with the directivity for the radio wave coming from the direction of ±30 degrees placing the direction of 0 degree in the center and enables transmission and reception to and from other devices in this direction. Sector 2 and subsequent sectors can be construed likewise.

Carrier detecting section 120 is connected with transmitting-receiving pairs 1-4, 2-5 and 3-6 of sector antenna 110, demodulates a radio wave received at one of the transmitting-receiving pairs, and, when some signal (i.e. carrier) including a beacon is detected in a superframe period, reports information showing the timing and the transmitting-receiving pairs at which the carrier is detected at first, to controlling section 132 of MAC section 130.

In addition to the function of transmitting and receiving a data frame to and from the upper layer, MAC section 130 has a function of receiving information (the timing and the transmitting-receiving pair at which a carrier is detected) from carrier detecting section 120, transmitting synchronization information to switch 150 and decoding and generating a beacon in each sub-superframe.

Controlling section 132 carries out synchronization control and switching timing control of switch 150. That is, when receiving the timing the carrier is detected, from carrier detecting section 120, controlling section 132 recognizes the timing as the top of a sub-superframe of the transmitting-receiving pair in which the carrier is detected and reports this timing to switch 150, beacon processing section 134 and frame processing section 136. Further, controlling section 132 reports the timing of the top of the sub-superframe in each sub-superframe, to switch 150.

When receiving the timing of the top of the sub-superframe, beacon processing section 134 determines the timing to send out the beacon of the device in this sub-superframe based on the timing. Beacon processing section 134 creates a beacon such that the beacon of the device is transmitted at this timing and passes the beacon to frame processing section 136.

Further, beacon processing section 134 detects beacons sent out from other devices, from frame processing section 136 and recognizes the presence of other device on a straight line in the transmitting-receiving pair, and carry out processing of determining a beacon slot (the beacon position in the beacon period) that does not overlap other devices as the beacon slot of the device, generating the beacon at the timing of this slot and passes the beacon to frame processing section 136.

When receiving the timing of the top of the sub-superframe from controlling section 132, frame processing section 136 determines the timing to send out the data period of the sub-superframe based on the received timing. Further, frame processing section 136 carries out processing required to create a MAC frame with respect to received data, and transmits data to the upper layer. Further, as for data which is received from the upper layer and which must be transmitted, frame processing section 136 converts the MAC frame into a signal of the physical layer and passes the signal to transmitting-receiving section 140.

Frame processing section 136 transmits and receives the data frame through an applicable transmitting-receiving pair per sub-superframe of a plurality of sub-superframes forming a superframe. Further, frame processing section 136 transmits and receives the data frame through the transmitting-receiving pair that currently transmits and receives the data frame, to and from sub-superframes other than the sub-superframe corresponding to the transmitting-receiving pair that currently transmits and receives the data frame.

Transmitting-receiving section 140 receives the beacon from beacon processing section 134 through frame processing section 136 and frame data from frame processing section 136, forms a sub-superframe, carries out signal processing required for the physical layer, modulates a signal, places the signal on a carrier and passes the carrier to switch 150. Further, transmitting-receiving section 140 demodulates the carrier received from switch 150, converts the carrier into a signal of the physical layer and passes the signal to frame processing section 136 and beacon processing section 134 through frame processing section 136.

Switch 150 carries out a switch operation such that signals can be transmitted and received only at the transmitting-receiving pair associated with the sub-superframe in the sub-superframe period. For example, during the period of superframe 311 of pair 1-4, switch 150 carries out a switch operation such that only transmitting-receiving pair 1-4, that is, sector 1 and sector 4, are connected with the transmitting-receiving section. During the beacon period, connection is established only by the transmitting-receiving pair associated with the sub-superframe. During the data period, although, basically, connection is established only by the transmitting-receiving pair associated with the sub-superframe, data may be received from a transmitting-receiving pair apart from the transmitting-receiving pair associated with the sub-superframe as described below.

Further, although controlling section 132 has been described with the present embodiment as a part of MAC section 130, controlling section 132 may be provided outside the MAC section or configured as a part of a PHY section together with switch 150 and transmitting-receiving section 140.

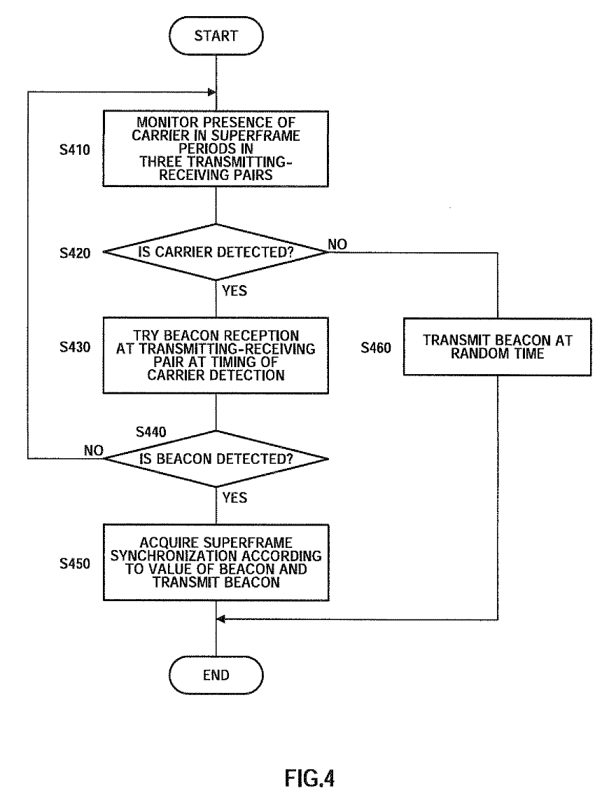

Next, the synchronization operation of superframe 300 according to the present embodiment will be described referring to FIG. 4.

First, with respect to three transmitting-receiving pairs 1-4, 2-5 and 3-6, carrier detecting section 120 monitors for a predetermined period whether or not the carrier is outputted in the period of superframe 300 received from other communication apparatus (S410). If carrier detecting section 120 detects a carrier (S420: YES), the detection timing of the carrier is at the top of the sub-superframe of the transmitting-receiving pair in which the carrier is detected, and refers to the timing of the start time of a sub-beacon period. Synchronization of superframe 300 is acquired based on this start time of the sub-beacon period.

Based on the detection timing of the selected carrier, that is, based on the start time of the sub-beacon period, beacon processing section 134 actually tries to receive a beacon using the sub-superframe received through the transmitting-receiving pair in which the carrier is detected (S430). However, if beacon processing section 134 tries to receive a beacon a plurality of times because the beacon is not detected by trying to receive the beacon, beacon processing section 134 tries again to receive a beacon by detecting a carrier at a timing other than timings beacon processing section 134 have tried. If beacon processing section 134 cannot detect a beacon as a result of the trial (S440. NO), the flow returns to step 410 and carrier detecting section 120 monitors for a predetermined period whether or not a carrier is outputted from three transmitting-receiving pairs in the period of superframe 300 received from other device.

If carrier detecting section 120 detects a beacon (S440: YES), controlling section 132 executes superframe synchronization according to the value of the beacon. To be more specific, the start time of the beacon period is found out by subtracting a beacon offset time from the time the beacon is received. If the start time of the beacon period is determined, it is possible to determine the timing the wireless communication apparatus transmits and receives the beacon, based on the start time of the beacon period.

Controlling section 132 commands beacon processing section 134 to transmit the beacon at this timing. Beacon processing section 134 transmits the beacon through frame processing section 136, transmitting-receiving section 140 and switch 150 (S450). Further, if carrier detecting section 120 does not detect a carrier in a predetermined period in step 420 (S420: NO), beacon processing section 134 judges that there is no device nearby and transmits a beacon at a random time (S460). By so doing, it is possible to make a chance to establish communication when other device comes closer.

Further, if signals are received at the same timing from a plurality of transmitting-receiving pairs, controlling section 132 selects one of the signals. Signals that are received earlier at transmitting-receiving pairs may be selected preferentially. Further, if there is a matching timing among sub-superframes from a plurality of transmitting-receiving pairs, synchronization between other sub-superframes is acquired based on the start time of the sub-superframe of such a transmitting-receiving pair and synchronization of overall superframe 300 is acquired.

If the start time of the sub-superframe period determined by carrier signal detection and the start time of the sub-beacon period of the beacon actually received are different, superframe synchronization is acquired according to the start time of the sub-beacon period of the beacon actually received.

The beacon outputting method in the sub-beacon period is basically the same as the beacon outputting method in the beacon period of known WiMedia. The difference is that the sub-beacon period comes three times in one superframe 300 and a beacon is transmitted once in each sub-beacon period, and, consequently, the beacon is transmitted a total of three times per superframe.

Each device is able to designate in each sub-beacon period the start time of the data slot for carrying out communication in the sub-superframe in DRPIE (Distributed Reservation Protocol Information Element) in the beacon of each device. Each device can request starting communication, by declaring information showing in which sub-superframe there is no device other than itself transmitting the beacon utilizing the beacon to be transmitted.

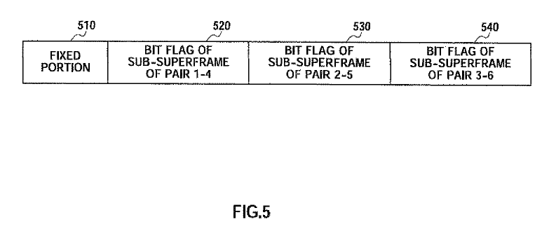

FIG. 5 shows “SSF Availability IE” (SSF: Sub SuperFrame, and IE: Information Element) for reporting a wireless communication sub-superframe. In case of a sub-superframe in which there is no device transmitting a beacon in the sub-superframe other than itself, a bit flag 0 matching this sub-superframe is set. Further, in case of a sub-superframe in which there are devices transmitting beacons in addition to the device, the bit flag 1 matching the sub-superframe is set. In “SSF Availability IS ID,” ID of SSF Availability IE is written. A device address and the like is written in fixed portion 510.

For example, if device C is communicating with other device A in sub-superframe 312 of pair 2-5 and device C does not detect beacons of other devices in sub-superframe 311 of pair 1-4 and sub-superframe 313 of pair 3-6, bit flag 520 of sub-superframe 311 of pair 1-4 becomes 0, bit flag 530 of sub-superframe 312 of pair 2-5 becomes 1 and bit flag 540 of sub-superframe 313 of pair 3-6 becomes 0.

With reference to the beacon in the above sub-superframe in which the bit flag is set, if other device that requests starting communication is the desirable party for other device to establish communication, the device transmits DRP Request to the desirable party to communicate with. If the party would receive DRP Request, the party returns its response that the party would receive DRP Request. That is, other party is able to make a reservation by designating the start time of the data slot for establishing communication in the sub-superframe and returning the response, and start communication according to this reservation. This is the method of efficiently utilizing the sub-superframe time of a transmitting-receiving pair for which there is no communicating party.

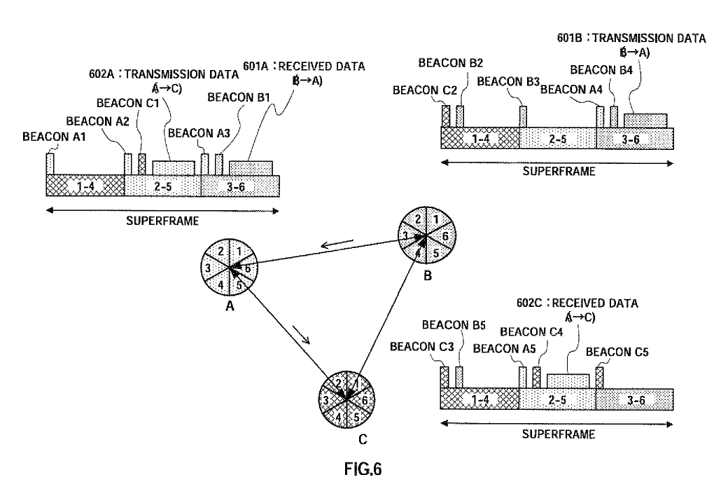

Next, referring to FIG. 6, the use conditions of superframes will be described in case where a plurality of devices according to the present embodiment acquire synchronization between each other. First, device A is near the extended line of transmitting-receiving pair 3-6 of device B and device B is near the extended line of transmitting-receiving pair 3-6 of device A, so that device A and device B are synchronized through transmitting-receiving pairs 3-6. As a result, frame processing section 136 of device A transmits beacon A3 and receives beacon B1 and received data 601A. Frame processing section 136 of device B receives beacon A4 and transmits beacon B4 and transmission data 601B. Transmission data 601B and received data 601A are the same as long as there is no error.

As a result, sub-superframes 313 of pairs 3-6 of device A and device B are synchronized and synchronization of superframes 300 is acquired.

Here, when transmitting a beacon, a device needs not report to the communicating party which sub-superframe of a transmitting-receiving pair is used. For example, when device A acquires synchronization with device B using sub-superframes 313 of pair 3-6, even if device B recognizes the transmitting-receiving pair synchronized as sub-superframe 311 of pair 1-4, as long as each device rotates superframe 300 at the same speed in a predetermined direction (counterclockwise or clockwise), the same transmitting-receiving pairs seem to be rotated when they are seen from surrounding and the phase difference is constant, so that synchronization is acquired.

Next, a case will be discussed where device A tries to acquire synchronization with device C in a state where device A and device B are synchronized through transmitting-receiving pairs 3-6. Device A and device C are located near the extended line of transmitting-receiving pairs 2-5 of device A and device C, so that it is possible to synchronize device A and device C using sub-superframes 312 of pairs 2-5. As a result, frame processing section 136 of device A transmits beacon A2 and transmission data 602A and receives beacon C1. Frame processing section 136 of device C receives beacon A5 and received data 602C and transmits beacon C4. Transmission data 602A and received data 602C are the same as long as there is no error.

When synchronization between device A and device B is acquired and synchronization between device A and device C is acquired in this way, device C and device B located close to the extended lines of transmitting-receiving pairs 1-4 are directed to transmitting-receiving pairs 1-4, so that it is possible to establish communication using these transmitting-receiving pairs. It is also possible at the same time to acquire synchronization of device B and device C using sub-superframe 311 of pair 1-4. Consequently, it is also possible at the same time to acquire synchronization between three devices, device A and device B, device A and device C, and device B and device C. This is the maximum advantage of this scheme. Further, in FIG. 6, device B transmits beacon B2 and receives beacon C2 and device C receives beacon B5 and transmits beacon C3.

As a switching method for transmitting-receiving pairs that can acquire such synchronization, there is a method of moving a transmitting-receiving pair counterclockwise or clockwise to an adjacent transmitting-receiving pair. In addition to this, when the number of transmitting-receiving pairs is N (where N is a natural number of two or greater), the transmitting-receiving pair is moved by skipping counterclockwise or clockwise every other M transmitting-receiving pairs (where M is a natural number and may be interpreted as zero when the transmitting-receiving pair moves to the adjacent transmitting-receiving pair, and N and M+1 are coprime natural numbers). For example, when M=2 and N=4 hold, if numbers 1, 2, 3 . . . are assigned to sectors counterclockwise, a transmitting-receiving pair moves sequentially and circulates in the order of sectors 1 and 5, sectors 4 and 8, sectors 7 and 3 (sectors 3 and 7) and sectors 2 and 6.

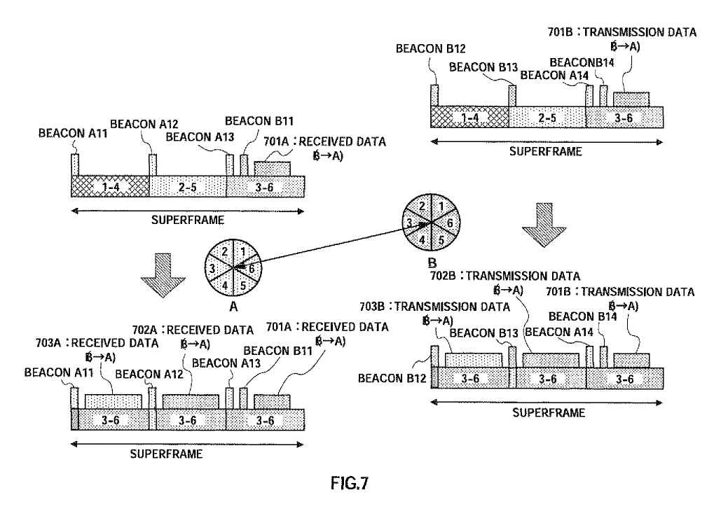

Next, referring to FIG. 7, a method of utilizing an empty sub-super frame will be described. The upper half of FIG. 7 shows that device A and device B carry out transmission and reception using only sub-superframes 313 of pairs 3-6. Frame processing section 136 of device B transmits beacon B14 and transmission data 701B and receives beacon A14. Frame processing section 136 of device A transmits beacon A13 and receives beacon B11 and received data 701A. There is no party for device A and device B other than in sub-superframe 313 of pair 3-6 to carry out transmission and reception, device A and device B simply transmit beacons A11 and A12 of device A and beacons B12 and B13 of device B.

The lower half of FIG. 7 shows that only empty beacon period 321 of sub-superframe 311 of pair 1-4 and empty beacon period 322 of sub-superframe 312 of pair 2-5 are operated by respective transmitting-receiving pairs, and data is exchanged by transmitting-receiving pair 306 in data periods 331 and 332. Transmission and reception are carried out through transmitting-receiving pairs matching with the original sub-superframes using only beacon periods because the devices need to transmit beacons to acquire synchronization with new affiliate devices and devices that can carry out transmission and reception as a result of move.

To be more specific, In sub-superframe 311 of pair 1-4 and sub-superframe 312 of pair 2-5 respectively, frame processing section 136 of device A transmits beacons A11 and A12. In data periods 331 and 332, frame processing section 136 of device A receives received data 702A and 703A using transmitting-receiving pair 3-6. Further, frame processing section 136 of device B transmits beacons B12 and B13 in sub-superframe 311 of pair 1-4 and sub-superframe 312 of pair 2-5, respectively, and frame processing section 136 of device B transmits transmission data 702B and 703B in data periods 331 and 332 using transmitting-receiving pair 3-6. The same applies to sub-superframe 313 of pair 3-6 as in the case where transmission and reception are carried out using only sub-superframe 313 of pair 3-6.

Here, frame processing section 136 transmits and receives the data frame through a transmitting-receiving pair that currently carries out transmission and reception, to and from sub-superframes other than the sub-superframe matching the transmitting-receiving pair that currently transmits and receives the data frame.

In this way, by effectively utilizing empty sub-superframes generated when transmitting-receiving pairs are switched, it is possible to transmit and receive more data to and from a great number of devices on a plane.

In this way, wireless communication apparatus 100 according to the present embodiment has: a plurality of transmitting-receiving pairs formed with two transmitting and receiving directions of opposite directivities from each other; sector antenna 110 that transmits and receives a directional radio wave in unit of each pair of a plurality of transmitting-receiving pairs; and switch 150 that switches a plurality of transmitting-receiving pairs over time, so that it is possible to secure the transmission distance and realize random multiple-access communication with terminals even with directional radio wave.

By contrast with this, if a single transmitting and receiving sector is rotated, when the single transmitting and receiving sector is rotated in the same direction, there is a problem that the single transmitting and receiving sectors are not directed to each other and transmission and reception are not possible. However, the wireless communication apparatus according to the present embodiment includes a plurality of transmitting-receiving pairs formed with two transmitting and receiving directions of opposite directivity and, consequently, when the transmitting-receiving pairs are rotated in the same direction, the transmitting-receiving pairs are arranged in a direction to be directed to each other, so that the wireless communication apparatus makes it possible to carry out transmission and reception.

Further, it is possible to maintain the transmission distance without decreasing the transmission output and realize random multiple-access communication with any terminals in two dimensional or three dimensional space even with directional radio wave.

### Embodiment 2

Various beam steering antennas are widely used as antennas that can switch directivities. The beam steering antenna enables fine control of directivities using software. A case will be described with Embodiment 2 where multiple-access in two dimensional space is carried out in the beam steering antenna.

The beam steering antenna does not have fixed directivity as in the sector antenna. Accordingly, each wireless communication apparatus needs to judge which direction and which direction must make a pair to be controlled. Further, the rotations of axes (hereinafter, simply “axes”) extending in directions in which antenna gains are maximum need to be coordinated between a plurality of wireless communication apparatuses. That is, it is necessary to share one transmitting and receiving direction between all wireless communication apparatuses (hereinafter “nodes” where appropriate) and adjust the direction of beam steering according to the shared transmitting and receiving direction. Sharing the transmitting and receiving direction can be realized by aligning axes of all nodes to the axis of one node in case of the distributed autonomous network. However, a problem of which node must be based on arises.

With the present embodiment, to solve this problem, each node sets a metric, which becomes a reference value for weighting the device of the node and exchanges the metric with other node using the beacon and the like. Then, each node is ordered according to the metric such that the node of the greater metric becomes a parent node and the node of the smaller metric becomes a child node.

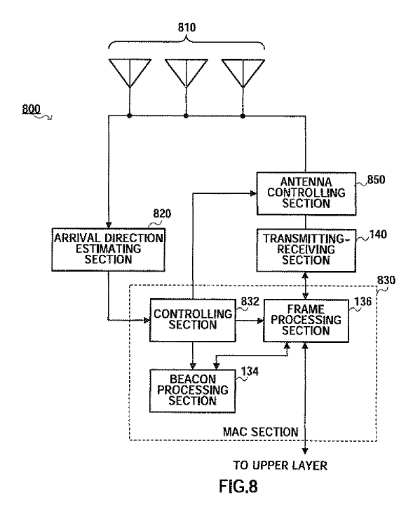

FIG. 8 is a block diagram showing a configuration of the wireless communication apparatus according to Embodiment 2 of the present invention and corresponds to FIG. 1 of Embodiment 1. The same components as in FIG. 1 will be assigned the same reference numerals and description thereof will be omitted.

Wireless communication apparatus 800 shown in FIG. 8 has beam steering antenna 810, arrival direction estimating section 820, MAC section 830 and antenna controlling section 850 instead of sector antenna 110, carrier detecting section 120, MAC section 130 and switch 150 shown in FIG. 1.

Beam steering antenna 810 is controlled by antenna controlling section 850, and switches the axial direction and transmits and receives a radio wave.

Arrival direction estimating section 820 is connected with beam steering antenna 810 and estimates the arrival direction of the radio wave outputted from other node. To be more specific, arrival direction estimating section 820 performs calculation to estimate the direction from which the radio wave arrives, based on the reception timing difference of beam steering antenna 810 and outputs the calculation result to MAC section 830.

MAC section 830 has controlling section 832 instead of controlling section 132 of MAC section 130 shown in FIG. 1. Controlling section 832 associates a received beacon frame with the direction from which the radio wave arrives estimated by arrival direction estimating section 820 arrives and resets beacon transmission data of this node and the designated axis for antenna controlling section 850. To be more specific, controlling section 832 executes axis alignment processing to align with other node and synchronization control processing to acquire frame synchronization with other node.

Antenna controlling section 850 controls the axial direction of beam steering antenna 810 according to control of controlling section 832.

Here, the principle of axis alignment between nodes will be described.

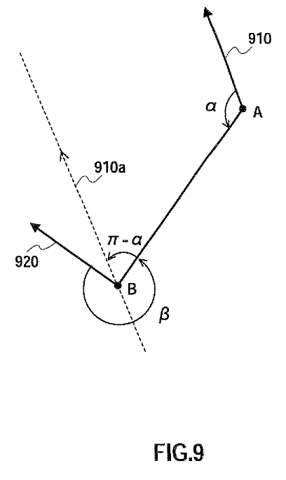

FIG. 9 illustrates the principle of axis alignment between nodes. A case will be described here where the axis of device B is aligned with the axis of device A when the radio wave is transmitted from the axis of device A to device B. Further, for ease of description, only one of axial directions facing opposite directions will be focused upon and the focused axial direction is simply referred to as “axial direction.” Further, the direction of device B seen from device A is represented as “direction B” and the direction of device A seen from device B is represented as “direction A.” Further, the following representations of angles will be based on the counterclockwise direction.

As shown in FIG. 9, the angle of direction B with respect to axial direction 910 of device A is α and the angle of direction A with respect to axis 920 of device B is β. Further, for ease of description, line 910a is drawn that is parallel with axial direction 910 of device A and that passes device B. In this case, as shown in FIG. 9, to align axial direction 920 of device B with axial direction 910 of device A, the direction rotated by the angle of β+(π−α) from current axial direction 920 of device B is set to new axial direction 920 of device B.

That is, by measuring angle α in device A, measuring angle β in device B and reporting angle α from device A to device B, it is possible for device B to align axial direction 920 of device B with axial direction 910 of device A. Further, if angle β is reported from device B to device A, it is possible for device A to align axial direction 910 of device A with axial direction 920 of device B by rotating current axial direction 910 of device A by angle α+(π−β) placing device A in the center.

To share the transmitting and receiving direction on the network, it is necessary to determine a node (hereinafter “parent node”) which serves as the reference of the axial direction. For example, by using the node for which the axial direction is determined as the parent node first, sharing the transmitting and receiving direction is possible. However, this method causes a problem when a plurality of networks in which there are parent nodes enable communication as a result of movement of nodes or the like.

With the present embodiment, as described above, a metric is set in each node and the parent node is determined dynamically according to the metric.

The metrics of nodes need to be set to values that do not completely match between nodes. The MAC address is identification information assigned to each node as a unique value. Accordingly, for example, the MAC address may be exploited as a metric.

Next, the operation of wireless communication apparatus 800 having the configuration shown in FIG. 8 will be described. Here, processings other than the above axis alignment processing and synchronization control processing are the same as in Embodiment 1, and so only axis alignment processing and synchronization control processing will be described.

First, the axis alignment processing will be described.

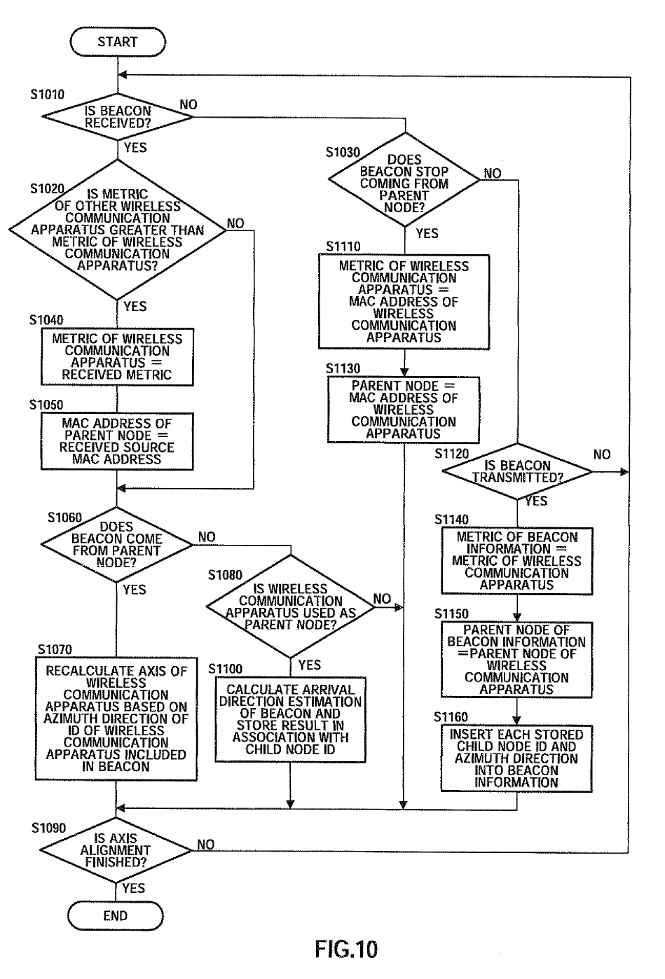

FIG. 10 is a flowchart showing the axis alignment processing by controlling section 832.

First, in step S1010, controlling section 832 tries to receive beacons in all directions and judges whether or not the beacons are received from other nodes. If controlling section 832 receives a beacon (S1010:YES), the flow proceeds to step S1020, and, if a beacon is not received (S1010:NO), the flow proceeds to step S1030.

With the present embodiment, if the source of the beacon is the parent node, beacon information includes the metric of the source. Further, if the source of a beacon is a node other than a parent node (hereinafter “child node”), beacon information includes the metric of the parent node with which the axis of this node is aligned. Each node notifies the metric in the beacon and continues notifying the metric until a new parent node comes in the vicinity or the current parent node goes out of the vicinity. Further, each node writes ID information of the node as ID information of the parent node when the node is on the root, and writes ID information of the parent node as ID information of the parent node when the node is not on the root. Then, each node writes a measured value of the direction of each child node such that the child node can adjust the direction by itself.

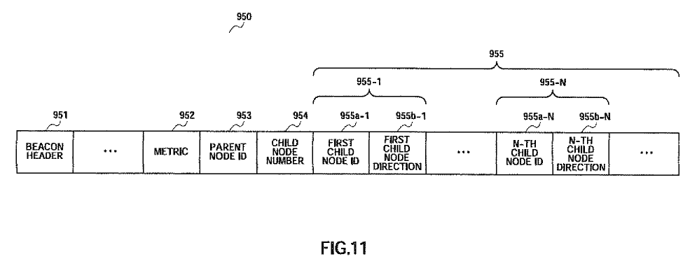

FIG. 11 shows a configuration of beacon information according to the present embodiment.

As shown in FIG. 1, beacon information 950 includes beacon header 951, metric 952, parent node ID 953, child node number 954 and child node information 955. Here, FIG. 11 shows a case where child node information 955-1 and 955-N regarding the first to N-th child nodes are included. Individual child node information 955 includes child node ID 955a and child node direction 955b.

ID information of the source of beacon information 950 (hereinafter simply the “source”) is written in beacon header 951. The metric of the source is written in metric 952. ID information of the source is written in parent node ID 953 when the source is the parent node, and ID information of the parent node of the source is written in parent node ID 953 when the source is the child node. The number of items of child node information 955 included in beacon information 950 is written in child node number 954. ID information of a child node with which the source can directly communicate with is written in child node ID 955a. The angle of the direction (hereinafter “azimuth direction”) of the child node shown by child node ID 955a with respect to the axial direction of the source seen from the source, is written in child node direction 955b.

Wireless communication apparatus 800 acquires ID information of a child node that can be communicated with directly, based on beacon information 950 received from other node. Then, wireless communication apparatus 800 acquires the azimuth angle of the child node from the radio wave transmitted from the child node that can be communicated with directly. Wireless communication apparatus 800 generates beacon information 950 from the metric and ID information of the parent node set in wireless communication apparatus 800 by the processing described later and the acquired ID information and the azimuth angle of the child node, and outputs beacon information 950 on a regular basis.

In step S1020 of FIG. 10, controlling section 832 judges whether or not the metric included in the received beacon is greater than the metric held in wireless communication apparatus 800. The metric held in wireless communication apparatus 800 is, for example, a MAC address of wireless communication apparatus 800 in the default state. Controlling section 832 proceeds to step S1040 if the received metric is greater than the metric of wireless communication apparatus 800 (S1020:YES).

In step S1040, controlling section 832 updates the metric of wireless communication apparatus 800 by the received metric.

Then, in step S1050, controlling section 832 updates ID information of the parent node of wireless communication apparatus 800 (for example, MAC address) by ID information (for example, MAC address) of the parent node included in the received beacon, and the flow proceeds to step S1060.

On the other hand, if the received metric is not greater than the metric of wireless communication apparatus 800 (S1020:NO), the flow proceeds straight to S1060.

Then, in step S1060, controlling section 832 judges whether or not a received beacon is outputted from the parent node based on whether or not ID information of the source of the beacon matches with ID information of the parent node included in the beacon. Controlling section 832 proceeds to step S1070 if the beacon is outputted from the parent node (S1060:YES) and proceeds to step S1080 if the beacon is outputted from the child node (S1060:NO).

In step S1070, controlling section 832 acquires the azimuth angle of wireless communication apparatus 800 included in the beacon as the azimuth angle of the child node and recalculates the axial direction that must be set in wireless communication apparatus 800 based on the acquired azimuth angle.

Then, in step S1090, controlling section 832 judges whether or not to finish axis alignment processing. Controlling section 832 returns to step S1010 if axis alignment processing continues (S1090:NO), and finishes a series of processings if axis alignment processing is finished (S1090:YES).

Then, in step S1080, controlling section 832 judges whether or not the source of the beacon uses wireless communication apparatus 800 as the parent node. Controlling section 832 proceeds to step S1100 if the source uses wireless communication apparatus 800 as the parent node (S1080:YES), and proceeds to step S1090 if the source does not use wireless communication apparatus 800 as the parent node (S1080:NO).

In step S1100, arrival direction estimating section 820 estimates the arrival direction of the beacon according to calculation. Then, controlling section 832 associates and stores the estimated azimuth angle of the beacon and ID information of the source of the beacon which becomes the child node of wireless communication apparatus 800, and the flow proceeds to step S1090.

On the other hand, in step S1030, controlling section 832 judges whether or not the condition that wireless communication apparatus 800 does not receive the beacon, wireless communication apparatus 800 is a child node and the beacon from a parent node stops coming is met. Controlling section 832 proceeds to step S1110 if the above condition is met (S1030:YES), and proceeds to step S1120 if the above condition is not met (S1030:NO).

In step S1110, controlling section 832 updates the metric of wireless communication apparatus 800 by ID information (here, MAC address) of wireless communication apparatus 800. That is, controlling section 832 sets wireless communication apparatus 800 as the parent node.

Then, in step S1130, controlling section 832 sets ID information (here, MAC address) of wireless communication apparatus 800 as ID information written in parent node ID 953 of when the beacon is outputted, and the flow proceeds to step S1090.

Further, in step S1120, controlling section 832 judges whether or not the timing has come for wireless communication apparatus 800 to output the beacon. Controlling section 832 proceeds to step S1140 if the timing has not come to output the beacon (S1120:YES), and returns to step S1010 if the timing has not come to output the beacon (S1120:NO).

In steps S1140 and S1150, controlling section 832 writes the current metric of wireless communication apparatus 800 in metric 952 in beacon information 950 and writes the metric of the current parent node (wireless communication apparatus 800 in case where wireless communication apparatus 800 is the parent node) of wireless communication apparatus 800. Then, in step S1160, controlling section 832 writes the ID information and the azimuth angle of the child node stored in step S1100, in child node information in beacon information 950. Then, controlling section 832 outputs the beacon and proceeds to step S1090.

According to such axis alignment processing, each node becomes a child node with respect to a node having the greatest weighted metric and redistributes the metric of the parent node as the metric of wireless communication apparatus 800. By this means, the metrics declared by all nodes are converged to a certain greatest metric. Further, the beacon outputted from the parent node includes a measured value for the radio wave arrival direction of the child node. By this means, the child node corrects the axis based on the measured value included in the beacon and the measured value of the direction of the parent node seen from wireless communication apparatus 800.

If the axis is fixed, for example, if the directions adopted by axes are fixed by the system by forming directions of 0 degree and 180 degrees as the first pair, directions of 60 degrees and 240 degrees as the second pair and the directions of 120 degrees and 300 degrees as the third pair, beam steering is performed in the fixed axial directions. By this means, similar to the sector antenna described in Embodiment 1, it is possible to use beam steering antenna 810.

Further, even if the axis is reconfigured, the direction of a beacon to be received is learned from earlier information, and, if the transmitting-receiving pair number is not taken into account, there would not be an error equal to or greater than 60 degrees. Consequently, it is obvious which transmitting-receiving pair is used by the transmitting-receiving pair that transmits and receives the previous beacon period to configure a beacon period. If not obvious, a method of waiting for a superframe, receiving a beacon at each transmitting-receiving pair and carrying out resetting, is possible.

Next, synchronization control processing will be described.

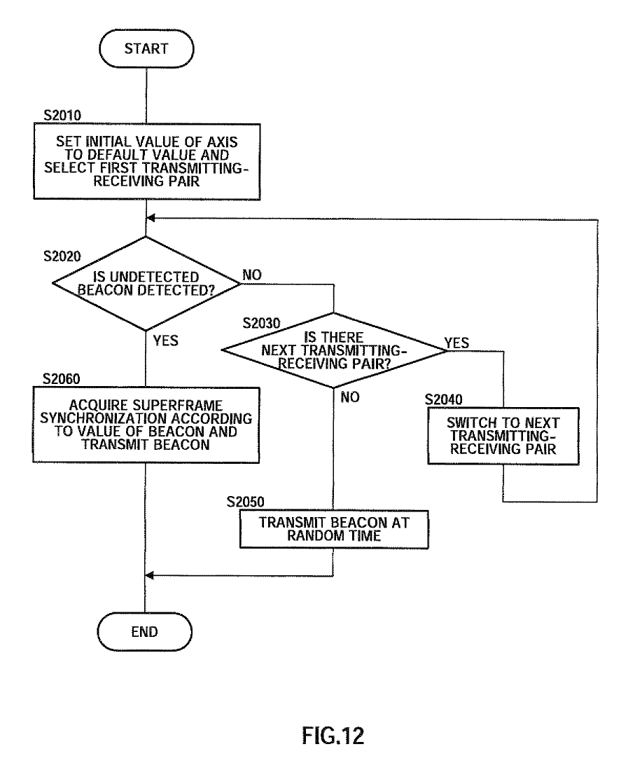

FIG. 12 is a flowchart showing synchronization control processing by controlling section 832. Controlling section 832 carries out synchronization control processing (described below), for example, at a first timing upon launching and when the axis is aligned with other node by axis alignment processing shown in FIG. 10. Here, both directions of the fixed axial direction will be regarded as the transmitting-receiving pair.

First, instep S2010, controlling section 832 sets the initial value of the axis to the default value for switching a transmitting-receiving pair of the beacon detection target, and selects the first transmitting-receiving pair.

Then, in step S2020, controlling section 832 judges whether or not a beacon outputted from other node is detected in the selected transmitting-receiving pair. Controlling section 832 proceeds to step S2030 if a beacon is not detected (S2020:NO).

In step S2030, controlling section 832 judges whether or not there is the next unselected transmitting-receiving pair. Controlling section 832 proceeds to step S2040 if there is the next transmitting-receiving pair (S2030:YES), and proceeds to step S2050 if there is no next transmitting-receiving pair (S2030:NO).

In step S2040, controlling section 832 switches selection to the next transmitting-receiving pair, and the flow returns to step S2020.

On the other hand, in step S2050, controlling section 832 does not detect a beacon in any direction, and, therefore, outputs a beacon at a random time and finishes a series of processings.

If a beacon is detected in any direction (S2020:YES) while steps S2020 to S2040 are repeated, the flow proceeds to step S2060.

In step S2060, controlling section 832 carries out superframe synchronization according to the value of the detected beacon, outputs the beacon and finishes a series of processings. Superframe synchronization is the same as in Embodiment 1 and so description thereof will be omitted.

In this way, according to synchronization control processing, it is possible to establish communication between wireless communication apparatuses 800 on the network.

In this way, the present embodiment makes it possible, using the beam steering antenna, to secure the transmission distance and realize random multiple-access even with directional radio wave similar to Embodiment 1. With the sector antenna described in Embodiment 1, the axis of the sector on the transmitting side and the axis of the sector on the receiving side do not match each other completely and slightly drift, so that, even though the directivity of the antenna has a certain degree of width, received output and characteristics are likely to decrease. In this regard, the beam steering antenna is used according to the present embodiment, so that it is possible to match the axis of the antenna on the transmitting side with the axis of the antenna on the receiving side in high accuracy and prevent a decrease in the received output and characteristics resulting from declination between the axis of the sector on the transmitting side and the axis of the sector on the receiving side. Consequently, better implementation is possible.

Further, although cases have been described with the above-described embodiments where the direction of each sector of the sector antenna and the direction of the axis of the beam steering antenna are arranged on two dimensional plane, the present invention is applicable to the beam steering antenna on three dimensional plane. In this case, one axis such as the direction of gravitational force is shared between all nodes, so that implementation becomes easy. If the direction of gravitational force is shared, by applying the principle of axis alignment described in Embodiment 2, the orientations of nodes in the vertical plane of gravitational force can be matched.

Further, the function and operation realized by the present embodiment may be realized by a computer program, and, in this case, a wireless communication apparatus has a memory (not shown) for storing this program, CPU for carrying out control and the like. Further, the media storing the program may be an external storage media such as EPROM, flash EEPROM or CD-ROM.

The disclosures of Japanese Patent Application No. 2006-251924, filed on Sep. 15, 2006, and Japanese Patent Application No. 2007-227910, filed on Sep. 3, 2007, including the specifications, drawings and abstracts, are incorporated herein by reference in their entirety.

### INDUSTRIAL APPLICABILITY

The present invention provides an advantage of securing the transmission distance and realizing random multiple-access communication with any terminal in two dimensional or three dimensional space even with directional radio wave, and is useful for a wireless communication apparatus and the like in ad-hoc network in a mobile environment.

1-11. (canceled)

12. A wireless communication apparatus that transmits and receives a directional radio wave and carries out ad-hoc network communication with another wireless communication apparatus, the wireless communication apparatus comprising:
an antenna that comprises a plurality of transmitting-receiving pairs which each transmit and receive the directional radio wave at the same time in opposite two directions; and
a controlling section that controls to switch the transmitting-receiving pairs which each transmit and receive the directional radio wave while controlling a timing.

13. The wireless communication apparatus according to claim 12, wherein the controlling section switches the transmitting-receiving pairs which each transmit and receive the directional radio wave on a regular basis.

14. The wireless communication apparatus according to claim 13, wherein:
the antenna comprises a sector antenna; and
the transmitting-receiving pairs each comprise a pair of antenna elements of opposite directivities.

15. The wireless communication apparatus according to claim 14, wherein, when a number of the transmitting-receiving pairs is N (where N is a natural number equal to or greater than two), the controlling section switches, on a regular basis, the N transmitting-receiving pairs every other M pairs, where N and (M+1) are coprime (where M is zero or a natural number).

16. The wireless communication apparatus according to claim 14, further comprising a detecting section that detects a carrier from the another wireless communication apparatus with respect to the plurality of transmitting-receiving pairs,
wherein the controlling section carries out processing of acquiring synchronization with the another wireless communication apparatus based on a timing and transmitting-receiving pair at which the carrier is detected.

17. The wireless communication apparatus according to claim 15, further comprising a frame processing section that carries out processing for transmitting and receiving a data frame,
wherein, in each sub-superframe of a plurality of sub-superframes which form a superframe and which are provided in association with a plurality of transmitting-receiving pairs, the frame processing section makes the data frame transmitted and received through an associated transmitting-receiving pair.

18. The wireless communication apparatus according to claim 16, further comprising a frame processing section that carries out processing for transmitting and receiving a data frame,
wherein, in each sub-superframe of a plurality of sub-superframes which form a superframe and which are provided in association with a plurality of transmitting-receiving pairs, the frame processing section makes the data frame transmitted and received through an associated transmitting-receiving pair.

19. The wireless communication apparatus according to claim 17, wherein, also in each sub-superframe other than the sub-superframe associated with the transmitting-receiving pair that currently transmits and receives the data frame, the frame processing section makes the data frame transmitted and received through the transmitting-receiving pair that currently carries out transmission and reception.

20. The wireless communication apparatus according to claim 17, wherein, also in each sub-superframe other than the sub-superframe associated with the transmitting-receiving pair that currently transmits and receives the data frame, the frame processing section makes the data frame transmitted and received through the transmitting-receiving pair that currently carries out transmission and reception.

21. The wireless communication apparatus according to claim 12, wherein:
the antenna comprises a beam steering antenna that carries out transmission and reception at the same time in two opposite directions, and, further comprises an antenna controlling section that switches a transmitting and receiving axial direction of the beam steering antenna over time; and
the controlling section controls a switching timing in the antenna controlling section such that the axial direction is switched on a regular basis.

22. The wireless communication apparatus according to claim 21, further comprising:
a metric setting section that sets a default value of a metric to a value unique to the wireless communication apparatus; and
a comparing section that judges whether or not a metric set in the another wireless communication apparatus is greater than the metric set in the wireless communication apparatus,
wherein, when the metric set in the another wireless communication apparatus is greater than the metric set in the wireless communication apparatus, the controlling section synchronizes the axial direction of the wireless communication apparatus with a transmitting and receiving axial direction of the another wireless communication apparatus, and updates the metric of the wireless communication apparatus by the metric set in the another wireless communication apparatus.

23. A wireless communication method for transmitting and receiving a directional radio wave and carrying out ad-hoc network communication with another wireless communication apparatus, the wireless communication method comprising:
in an antenna comprising a plurality of transmitting-receiving pairs that enable transmission and reception of the directional radio wave at the same time in opposite two directions, transmitting and receiving the directional radio wave in a unit of a transmitting-receiving pair; and
switching the transmitting-receiving pairs which each transmit and receive the directional radio wave on a regular basis.
